(19) United States
(12) Patent Application Publication
(10) Pub. No.: US 2010/0185887 A1
(43) Pub. Date: Jul. 22, 2010

(54) APPARATUS AND METHOD FOR SAVING POWER IN PORTABLE TERMINAL USING ETHERNET

(75) Inventor: Min-Yong AUM, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/691,854

(22) Filed: Jan. 22, 2010

(30) Foreign Application Priority Data
Jan. 22, 2009 (KR) 10-2009-0005318

(51) Int. Cl. G06F 1/32

(52) U.S. Cl. 713/324; 713/300

(57) ABSTRACT

A method for saving power in a portable terminal includes determining whether an Ethernet cable is communicatively connected to an Ethernet modem; and when the Ethernet cable is not in communication with the Ethernet modem, intermittently supplying power to the Ethernet modem.

### CLAIM OF PRIORITY

This application claims the benefit under 35 U.S.C. §119(a) to a Korean patent application filed in the Korean Intellectual Property Office on Jan. 22, 2009 and assigned Serial No. 10-2009-0005318, the entire disclosure of which is hereby incorporated by reference.

### BACKGROUND OF THE INVENTION

1. Field of the Invention

The present invention relates generally to an apparatus and a method for lowering power consumption and its operating temperature when Ethernet is used in a portable terminal (laptop, net book, etc.)

2. Description of the Related Art

A portable terminal such as multifunction terminal typically includes a wireless communication means. However, outside the wireless coverage, it is necessary to use a wired communication means. The wired communication means needs to be mounted in the main body or a peripheral device servicing the wired communication.

In general, since Ethernet is used only on a static platform (desktop, server, laptop, etc.), there is no need to apply the Ethernet to the portable terminals. In addition, as the Ethernet has been considered for the static platform, its power management was not needed.

However, due to the miniaturization of the platform, the division between the static platform and the mobile platform tends to disappear. In this respect, it is necessary to manage the power of the Ethernet.

### SUMMARY OF THE INVENTION

An aspect of the present invention is to address at least the above mentioned problems and/or disadvantages and to provide at least the advantages described below. Accordingly, an aspect of the present invention is to provide an apparatus and a method for providing saving power in a portable terminal using Ethernet.

Another aspect of the present invention is to provide an apparatus and a method for reducing power consumption in an unplug Ethernet status.

According to one aspect of the present invention, a method for saving power in a portable terminal includes determining whether an Ethernet cable is coupled to an Ethernet modem; and when the Ethernet cable is not coupled to the Ethernet modem, intermittently supplying power to the Ethernet modem.

According to another aspect of the present invention, an apparatus of a portable terminal for saving power includes an Ethernet modem coupled to an Ethernet cable; and a controller determining whether the Ethernet cable is coupled to the Ethernet modem, and when the Ethernet cable is not coupled to the Ethernet modern, intermittently supplying power to the Ethernet modem.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will become more apparent to those skilled in the art from the following detailed description taken in conjunction with the accompanying drawings, in which:

FIG. 1 illustrates an Ethernet status detecting process according to an exemplary embodiment of the present invention;

FIG. 2 illustrates an Ethernet power saving method according to an exemplary embodiment of the present invention;

FIG. 3 illustrates a structure of a portable terminal according to an exemplary embodiment of the present invention;

FIG. 4 illustrates the power reduction degree of an Ethernet chip (modem) when the Ethernet power is saved according to an exemplary embodiment of the present invention; and

FIG. 5 illustrates the power reduction degree of the portable terminal when the Ethernet power is saved according to an exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. For the purposes of simplicity and to avoid redundancy, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

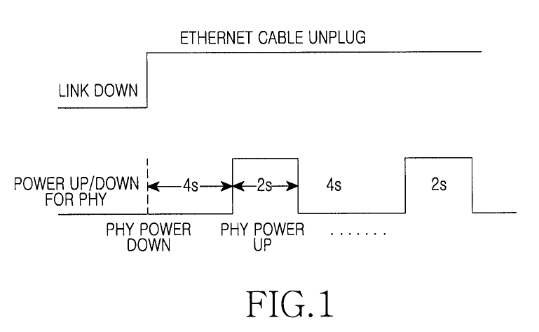

FIG. 1 depicts an Ethernet status detecting process according to an exemplary embodiment of the present invention.

In FIG. 1, when the plus Ethernet status is changed to the unplug Ethernet status, the conventional process performs a continuous polling for the Ethernet to detect Ethernet cable connection when an Ethernet cable is not connected. As a result, a continuous power supply is required to an Ethernet related chip (PHY, HUB, etc.).

However, the continuous polling is unnecessary to detect the plug Ethernet status in the unplug Ethernet status. To address this, the inventive method provides an intermittent polling to reduce the entire power consumption and accordingly decreases the heat generated therein.

When an Ethernet cable is unplugged and the Ethernet link down is detected, the intermittent polling of the present invention performs the polling for 2 seconds and stands by for 4 seconds. That is, the power is supplied to the Ethernet for 2 seconds and no power is supplied to the Ethernet for 4 seconds, thus reducing the power consumption. By modifying an Ethernet driver, this function can be realized.

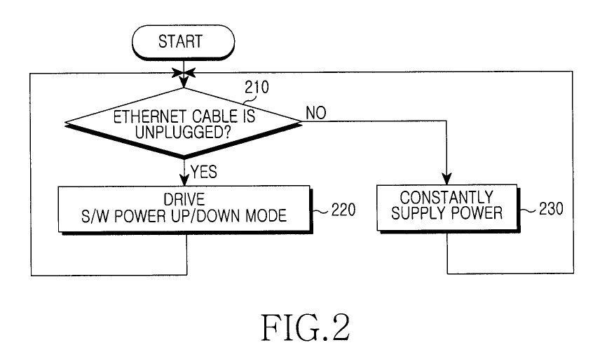

FIG. 2 is a flowchart of an Ethernet power saving method according to an exemplary embodiment of the present invention.

In FIG. 2, a power manager of a portable terminal determines whether the Ethernet cable is unplugged. When the Ethernet cable is unplugged in step 210, the portable terminal conducts the software (S/W) power up/down for an intermittent polling in step 220. That is, the portable terminal intermittently regulates the power supplied to the Ethernet. For example, referring back to FIG. 1, the power is supplied to the Ethernet for 2 seconds and not supplied for 4 seconds. This step is repeated until the Ethernet cable is plugged.

When the Ethernet cable is plugged in step 210, the portable terminal constantly supplies the power to the Ethernet in step 230 and repeats this step until the Ethernet cable is unplugged.

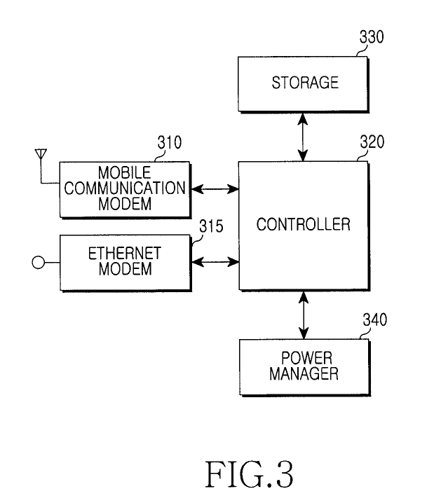

FIG. 3 is a block diagram of the portable terminal whereto the teachings of the present invention is applied to in accordance with an exemplary embodiment of the present invention.

The portable terminal of FIG. 3 includes a mobile communication modem 310, an Ethernet modem 315, a controller 320, a storage 330, and a power manager 340.

The mobile communication modem 310 is a module for communicating with other mobile communication node and includes a wireless processor and a baseband processor. The wireless processor converts a signal received via an antenna to a baseband signal and outputs the baseband signal to the baseband processor. The wireless processor converts a baseband signal output from the baseband processor to a radio signal to wirelessly transmit and transmits the radio signal via the antenna.

The Ethernet modem 315 is a module for communicating with other Ethernet node, and includes a wired processor and a baseband processor. The wired processor converts an Ethernet signal received over an Ethernet path to a baseband signal and outputs the baseband signal to the baseband processor. The wired processor converts a baseband signal output from the baseband processor to an Ethernet signal to transmit in the Ethernet path and transmits the Ethernet signal over the Ethernet path.

The controller 320 controls the overall operations of the portable terminal. Specifically, the controller 320 controls the power manager 340, the Ethernet modem 315, and the mobile communication modem 310.

The storage 330 stores a program for controlling the operations of the portable terminal and generates data temporary during the program execution.

The power manager 340 examines whether the Ethernet cable is unplugged. In the unplug status, the power manager 340 performs the software (S/W) power up/down for the Ethernet modem 315 for executing intermittent polling. That is, the power manager 340 intermittently regulates the power supplied to the Ethernet modem 315 according to a predefined pattern.

As described earlier, the power manager 340 supplies the power to the Ethernet modem 315 for 2 seconds and supplies no power to the Ethernet modem 315 for 4 seconds. This process is repeated until the Ethernet cable is plugged. It should be noted that the intermittence interval shown in FIG. 1 is for illustrative purpose, and other combination of lapse period can be performed during the intermittent polling.

When the Ethernet cable is plugged, the power manager 340 constantly supplies the power to the Ethernet modem 315 and repeats this process until the Ethernet cable is unplugged.

In alternate embodiment, the Ethernet link may be in a constant connection with the controller of a portable terminal, and the intermittent supplying of power can be selectively performed depending on when the terminal is in an Ethernet communication mode or not. If the terminal is in the operation mode to be in communication with another source via the Ethernet connection, the power can be halted when the terminal is not engaging communication via the Ethernet connection.

As constituted above, the controller 320 can function as the power manager 340. Herein, the functions of controller 320 are separately provided to distinguish their functions. However, in the actual product, the controller 320 can process all or part of the functions of the power manager 340.

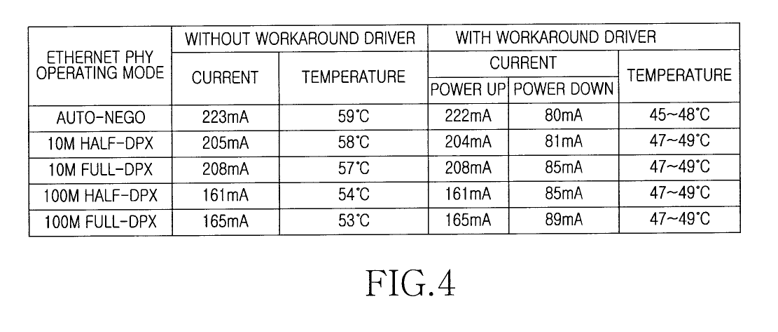

FIG. 4 illustrates the power reduction chart of an Ethernet chip (modem) when the Ethernet power is saved according to an exemplary embodiment of the present invention.

As shown, as for the current consumed by the conventional technique, 223 mA is continuously consumed until the cable is connected. By contrast, the present invention consumes 222 mA for 2 seconds but 80 mA for 4 seconds.

In terms of the heat, the conventional technique constantly generates the heat of 59 degree C until the cable is connected, whereas the present invention produces the heat of 45˜48 degree C.

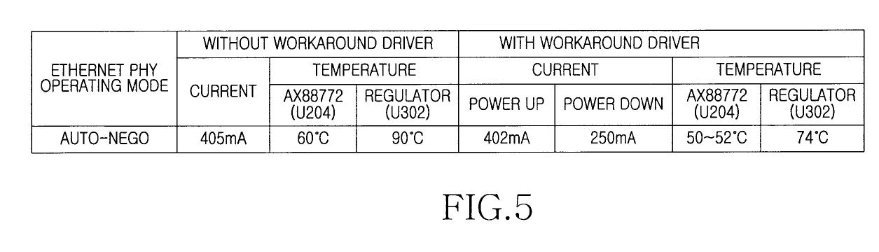

FIG. 5 illustrates the power reduction chart of the portable terminal when the Ethernet power is saved according to an exemplary embodiment of the present invention.

In terms of the power consumption, while the conventional technique constantly consumes the current 405 mA until the cable is connected, the present invention consumes 402 mA for 2 seconds but 250 mA for 4 seconds.

In terms of the heat, the conventional technique constantly generates the heat of 60˜90 degree C. until the cable is connected, whereas the present invention produces the heat of 50˜74 degree C.

Having thus described a preferred embodiment of a method for reducing power consumption and its operation heat in a portable terminal during Ethernet mode, it should be apparent to those skilled in the art that certain advantages have been achieved. The foregoing is to be constructed as only being an illustrative embodiment of this invention. Persons skilled in the art can easily conceive of alternative arrangements providing a functionality similar to this embodiment without any deviation from the fundamental principles or the scope of this invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for saving power in a portable terminal, comprising:
determining, by a controller, whether an Ethernet cable is communicatively coupled to an Ethernet modem; and
if the Ethernet cable is not communicatively coupled to the Ethernet modem, intermittently supplying, by the controller, power to the Ethernet modem.

2. The method of claim 1, further comprising:
supplying, by the controller, a continuous power to the Ethernet modem when the Ethernet cable is coupled to the Ethernet modem.

3. The method of claim 1, wherein the intermittent supplying of the power to the Ethernet modem comprises:
supplying, by the controller, the power to the Ethernet modem during a first interval; and
halting, by the controller, the power to the Ethernet modem during a second interval.

4. An apparatus of a portable terminal for saving power, comprising:
an Ethernet modem coupled to an Ethernet cable; and
a controller determining whether the Ethernet cable is coupled to the Ethernet modem, and if the Ethernet cable is not coupled to the Ethernet modem, intermittently supplying power to the Ethernet modem.

5. The apparatus of claim 4, wherein the controller supplies a continuous power to the Ethernet modem when the Ethernet cable is coupled to the Ethernet modem.

6. The apparatus of claim 4, wherein the controller intermittently supplies the power to the Ethernet modem by supplying the power to the Ethernet modem during a first interval and halting the power to the Ethernet modem during a second interval.
